(19) United States
(12) Patent Application Publication
(10) Pub. No.: US 2017/0268902 A1
(43) Pub. Date: Sep. 21, 2017

(54) Portable, Externally Mounted Device for Aircraft to Provide User Selected Readings of Airspeed, Pressure, Temperature, Orientation, Heading, Acceleration, and Angular Rate

(71) Applicants: Alexander Rolinski, Eustis, FL (US); Brandon Marsell, Cocoa, FL (US)

(72) Inventors: Alexander Rolinski, Eustis, FL (US); Brandon Marsell, Cocoa, FL (US)

(21) Appl. No.: 15/420,270

(22) Filed: Jan. 31, 2017

Related U.S. Application Data
(60) Provisional application No. 62/308,271, filed on Mar. 15, 2016.

(51) Int. Cl. G01C 23/00

(52) U.S. Cl. CPC G01C 23/00

(57) ABSTRACT

The present invention relates to a portable, externally mounted device for aircraft used to provide user selectable readings of airspeed, pressure, temperature, orientation, heading, acceleration, and angular rate. The present invention is self-contained and wireless and is portable from aircraft to aircraft. The present invention is externally mounted on the aircraft.

### CROSS-REFERENCE TO RELATED APPLICATIONS

This application takes benefit of U.S. Prov. App. No. 62/308,271 filed Mar. 15, 2016 and hereby incorporates it in its entirety by reference.

### FIELD OF THE INVENTION

The present invention relates to a portable, externally mounted device for aircraft used to provide user selectable readings of airspeed, pressure, temperature, orientation, heading, acceleration, and angular rate. The present invention is self-contained and wireless and is portable from aircraft to aircraft. The present invention is externally mounted on the aircraft.

### BACKGROUND OF THE INVENTION

Currently, there is no simple, inexpensive way for aircraft pilots to view and record flight data that includes airspeed, pressure (altimeter), temperature, orientation, heading, acceleration, and angular rate. Current devices for monitoring this data are very complex and expensive. They are hard mounted to the aircraft and permanently wired to one or more screens or instruments mounted in the aircraft to display the readings. Obviously, these devices are not portable and do not interface with portable media devices. Further, not all flying devices have instrumentation. Hang-gliders for example are ordinarily not equipped with instrumentation. Also, not all flying devices have the same type or kind of devices installed. For example, not all flying devices are equipped with instrumentation that captures and records atmospheric temperature.

Therefore, it is a first goal of the present invention to provide a simple and inexpensive way for aircraft pilots to view and record flight data including, but not limited to, airspeed, pressure (altimeter), temperature, orientation, heading, acceleration, and angular rate.

It is a second goal of the present invention to provide a portable device that may be transported from aircraft to aircraft. Such a device will generally not include indicators or displays, but will interoperate with an application on a cellular telephone or tablet computer. Data will be communicated wirelessly between the present invention and the cellular telephone or tablet computer.

Finally, it is a third goal of the present invention to provide a device that presents consistent, equivalent capture and recording of the same flight data no matter what kind of flying machine is used.

### SUMMARY OF THE INVENTION

The exemplary embodiment of the present invention comprises two components: 1) A data sensing and collection device with wireless connectivity to a displaying media device such as a cellular telephone or tablet computer; and, 2) An application running on the displaying media device capable of receiving, displaying, and storing the transmitted data.

The data sensing and collection device with wireless connectivity is contained in an aerodynamic housing attached to a mounting stalk. The aerodynamic housing of the data sensing and collection device is generally an elongate ovoid in shape with the leading end being slightly larger than the trailing end. The mounting stalk of the device may be permanently or semi-permanently attached to the aircraft. Ordinarily, the mounting stalk of the device is attached to the aircraft in a location near the leading edge of one of the wings of the flying machine. Similarly, the mounting stalk may be attached to the fuselage or some other surface of the flying machine.

The data sensing and collection device is comprised of the following subsystems: 1) A battery; 2) A pitot tube and associated digital differential pressure sensor; 3) A digital temperature sensor; 4) A digital pressure sensor (altimeter); 5) A gyroscope; 6) An accelerometer; 7) A magnetometer; 8) A processor; and, 9) A wireless transceiver capable of transmitting collected data from the data sensing and collection device to the application running on the displaying media device.

The exemplary embodiment of the data sensing and collection device is configured with the pitot tube oriented parallel to the long axis of the aerodynamic housing and extending forward from the leading end of the device. The data sensing and collection device is aligned such that the pitot tube extends in the direction of flight.

The application is written to operate on a cell telephone or a tablet computer. The cell telephone or tablet computer has a wireless transceiver compatible with the exemplary embodiment of the data sensing and collection device and capable of receiving and transmitting information from and to it. The application has a multiplicity of display windows each capable of displaying information received from the data sensing and collection device. For each type of data transmitted by the data sensing and collection device, the application is capable of displaying at least: 1, ) The instantaneous current value in a numeric format; and, 2) The instantaneous and historic values in a graphical format. Also, the application is capable of collectively displaying each type of data transmitted by the data sensing and collection device in one window.

The system is used in the following manner: First, the user attaches the stalk of the data sensing and collection device to the wing or other surface of the aircraft before entering the flying machine. Next, the user aligns the data sensing and collection device relative to the stalk such that the long axis of the data sensing and collection device (and particularly the pitot tube) is parallel to the direction of travel of the flying device. Next, the user secures the clamp on the stalk affixing the data sensing and collection device and stalk at their relative locations. Next, the user powers on the data sensing and collection device. Next, the user powers on his cellular telephone or tablet computer. Next, the user activates the application installed on his cellular telephone or tablet computer and establishes communication with the data sensing and collection device. Next, the user selects what data he wishes to see displayed by the application. Next, the user flies the flying machine. Finally, the user observes the data collected by the data sensing and collection device via the application.

### BRIEF DESCRIPTION OF THE DRAWINGS

FIG. 1 is a block diagram showing the data sensing and collection device.

FIG. 2 is a flow diagram illustrating the process of linking to the data sensing and collection device using the application.

FIG. 3 is a flow diagram illustrating the process of using the application to display information derived from the data sensing and collection device.

### DETAILED DESCRIPTION OF THE PREFERRED EMBODIMENT

In the following discussion references are made to a variety of enabling technologies and techniques traditionally used to deploy software-based web services. For example, the term “application” will be used to connote one or more software applications or programs resident on a cellular telephone or tablet computer or computers operating individually or in concert to achieve a certain set of operational features. Without limitation such applications are implemented Apple iOS or Swift or Android Java or LUA. Those having skill in the art however will recognize that numerous other equivalent development environments that may be used.

Similarly, references are made to “cellular telephones” and “tablet computers.” Such devices are well known. As above however, those having skill in the art will readily recognize that other equivalent devices are commercially available and readily adapted to the teachings of the present invention.

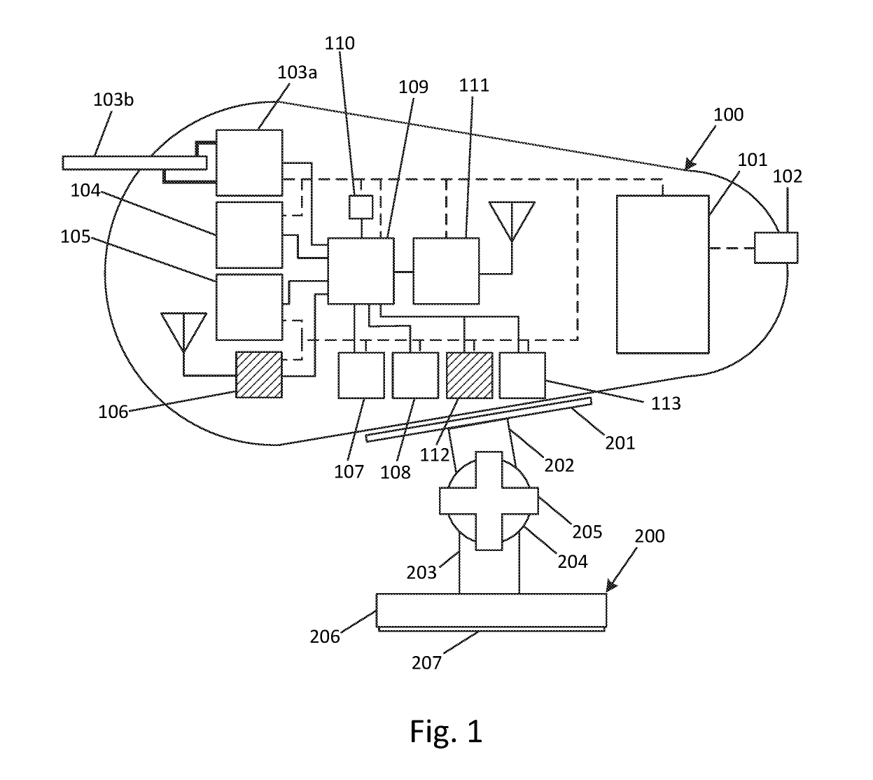

Turning now to FIG. 1, an exemplary embodiment of the present invention comprises the following hardware components: 1) A data sensing and collection device 100 (DSCD) for sensing, collecting, and transmitting flight data to a cellular telephone or tablet computer; and, 2) A stalk 200 for adjustably mounting data sensing and collection device 100 to a wing or other exterior surface of a flying machine.

The exemplary embodiment of data sensing and collection device 100 is comprised of the following elements: 1) Battery 101 and a battery charging port 102; 2) Differential pressure sensor 103a and attached pitot tube 103b;3) Barometric altimeter (pressure sensor) 104; 4) Temperature sensor 105; 5) Gyroscope 107; 6) Accelerometer 108; 7) Magnetometer 113; 8) Microcontroller 109 and storage facility 110; and, 6) Radio transceiver 111.

Battery 101 is used to supply power to the remaining components in data sensing and collection device 100. Battery 101 may be removable or fixed inside data sensing and collection device 100. Battery 101 maybe rechargeable. If battery 101 is rechargeable, then battery charging port 102 is equipped and interconnected to battery 101. Those having skill in the art will recognize that battery 101 may be omitted if data sensing and collection device 100 is wired to the electrical supply system of the flying machine.

Differential pressure sensor 103a is plumbed to pitot tube 103b such that differential pressure sensor 103a can sense the static pressure and total pressure of pitot tube 103b. The difference between these two pressures is the dynamic pressure. Dynamic pressure is related to the frontal pressure seen by the flying machine due to its motion through the air. Thus, the velocity of the flying machine can be calculated from the dynamic pressure. Since pitot tube 103b is exposed to the outside of the flying machine, some level of thermal protection may be appropriate. For example, it may be necessary to supply pitot tube 103b with a heating coil.

Barometric altimeter (pressure sensor) 104 is used to measure the altitude of data sensing and collection device 100. Barometric altimeter (pressure sensor) 104 may be calibrated or not. It is obvious that the higher one flies above the surface of the Earth, the lower the atmospheric pressure recorded by the sensor. It is this barometric measurement that allows the computing of altitude.

Temperature sensor 105 reads the temperature of the air around data sensing and collection device 100.

Gyroscope 107 forms part of a traditional Inertial Measurement Unit (IMU). As such, gyroscope 107 is constructed of three gyroscope monitoring devices aligned such that their axes are orthogonal with respect to one another. Gyroscope 107 provides a stable, three-dimensional reference for data sensing and collection device 100.

Similarly, accelerometer 108 also forms part of a traditional IMU. Accelerometer 108 is constructed of three acceleration monitoring devices aligned such that their axes are orthogonal with respect to one another. Accelerometer 108 provides instantaneous inputs regarding the three dimensional acceleration for data sensing and collection device 100.

Similarly, magnetometer 113 also forms part of a traditional IMU. As such, magnetometer 113 is constructed of three magnetic field monitoring devices aligned such that their axes are orthogonal with respect to one another. Magnetometer 113 provides instantaneous inputs regarding the three dimensional character of the magnetic field in which data sensing and collection device 100 is operating. Magnetometer 113 assists calibration against orientation drift.

Microcontroller 109 and storage facility 110 perform all computational tasks for data sensing and collection device 100. Microcontroller 109 is ordinarily an ARM processing system, but those having skill in the art will recognize that there are numerous equivalent alternatives. Storage facility 110 combines some amount of random access memory and read only memory. In one embodiment of the present invention microcontroller 109 and storage facility 110 may be implemented on the same physical device. Ordinarily, storage facility 110 contains instructions implementing the operating program that controls and operates data sensing and collection device 100.

Radio transceiver 111 is used to communicate with an attached cell telephone or tablet computer and ordinarily supports the Bluetooth protocol. Those having skill in the art will readily recognize that there are numerous other protocols that may be used including Wi-Fi.

This basic collection of devices is sufficient to calculate airspeed, pressure (altitude), temperature, orientation, heading, acceleration, and angular rate. However, those having skill in the art will readily recognize that there are numerous other devices that may be added to data sensing and collection device 100. For example, an alternative embodiment of data sensing and collection device 100 has GPS receiver 106. Similarly, an alternative embodiment of data sensing and collection device 100 may be equipped with digital compass 112.

All of these devices are powered by battery 101 and attached to microcontroller 109 and storage device 110.

The exemplary embodiment of stalk 200 includes a mounting head 201 designed to affix to data sensing and collection device 100. Mounting head 201 is permanently affixed to distal shaft 202. Proximal shaft 203 is attached to mounting base 206. Mounting base 206 is equipped with adhesive pad 207 on its bottom side. Adhesive pad 207 is a double sided adhesive pad. One side is attached to the bottom of mounting base 206 while the other side is affixed to the exterior surface of the flying machine. Distal shaft 202 is affixed to mounting clamp 204. Mounting clamp 204 is friction adjustable by mounting clamp bolt 205. In use mounting clamp 204 affixes over a mating hole in proximal shaft 203. The user then tightens mounting clamp bolt 205 down securing distal shaft 202 and proximal shaft 203 together. Ordinarily, the user adjusts data sensing and collection device 100 such that pitot tube 103b proceeds in the direction of flight of the flying machine.

It will be obvious to those having skill in the art that the disclosed design of stalk 200 and attached data sensing and collection device 100 is adjustable in only one axis. It will be obvious to those having skill in the art that stalk 200 may be equipped with more than one mounting clamp 204 and that such mounting clamps may be aligned 90° with respect to one another. By this means stalk 200 and attached data sensing and collection device 100 may be aligned in two axes. Obviously, stalk 200 may be equipped with more than one mounting clamp 204 aligned at an angle other than 90°.

Data sensing and collection device 100 provides data to a software application operating on a cellular telephone or tablet computer. The application displays and/or records the data for later use. The software application has two basic functions: 1) Initializing the data communication link between data sensing and collection device 100 and the application; and, 2) Recording and displaying the data collected from an attached data sensing and collection device 100.

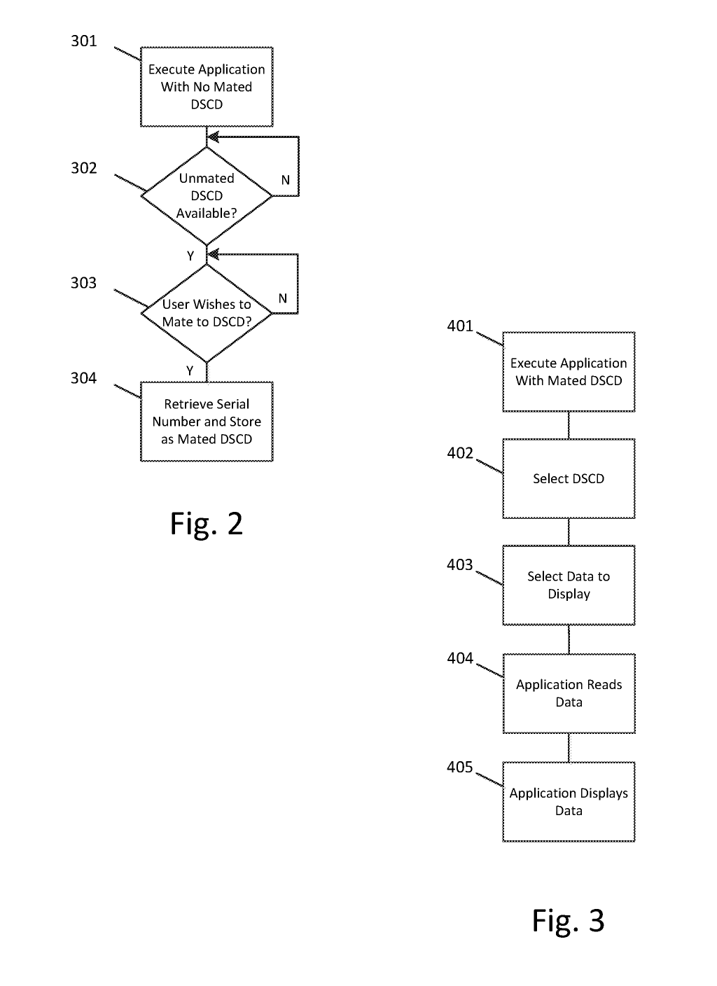

Turning now to FIG. 1 and FIG. 2, the process undertaken by the software application initializing the data communication link between data sensing and collection device 100 and the application is shown. First, the user downloads and executes the software application with no mated DSCD (301). Ordinarily, this would occur when the user first installs the software application on a cellular telephone or tablet computer. Next, the software application queries the surrounding area to determine if there are any unmated DSCDs present (302). If the software application does not locate any unmated DSCDs, the software application repeats this step. If the software application locates an unmated DSCD, the software application queries the user to determine if the user wishes to mate with the identified DSCD (303). If the user does not wish to mate with the identified unmated DSCD, the software application repeats this step. If the user does wish to mate with the identified unmated DSCD, the software application retrieves and stores the selected DSCD's serial number (304). From this point forward the software application installed on the user's cellular telephone or tablet computer attempts to connect to and collect information from the DSCD with the serial number collected during the mating process.

Turning now to FIG. 1 and FIG. 3, the process undertaken by the software application after it has been mated to a data sensing and collection device 100 is shown. First, the user executes the software application with a mated DSCD nearby (401). Next, the software application queries the user to select a mated DSCD to interrogate (402). This step will be performed only if the user has more than one DSCD mated with the software application. Next, the software application requests that the user select the data to be displayed (403). This step is used to determine which of the multiplicity of types of data provided by the DSCD are actually displayed by the application software. For example, the user may wish to see altitude data displayed. Or, alternately, the user may wish to see altitude data and speed data displayed simultaneously. Or, alternately, the user may wish to see altitude data and speed data displayed graphically so that an arbitrary history of data may be viewed. Or, alternately, the user may wish to see a simulated, graphical representation of gauges such as an airspeed indicator, an altimeter, a thermometer, an attitude indicator, a vertical speed indicator, a heading indicator, or, a turn coordinator. Next, the software application reads the data the user has selected for display (404). Finally, the software application displays the data the user has selected on the display (405).

Referring again to FIG. 1, the system is used in the following manner: First, the user attaches stalk 200 affixed to data sensing and collection device 100 to the wing or other surface of the flying machine. Ordinarily, this is done by removing a paper covering over an adhesive layer on adhesive pad 207 on the bottom of mounting base 206. It will be obvious to those having skill in the art that other means of affixing mounting base 206 to an external aircraft surface are readily conceivable. Next, the user aligns data sensing and collection device 100 relative to stalk 200 such that the long axis of the data sensing and collection device 100 (and particularly the long axis of pitot tube 103b) is parallel to the direction of travel of the flying machine. Next, the user secures mounting clamp 204 by tightening mounting clamp bolt 205 on stalk 200 thus affixing data sensing and collection device 100 and stalk 200 at their relative locations. Next, the user powers on data sensing and collection device 100. The user performs these steps before entering the flying machine. Next, the user powers on his cellular telephone or tablet computer. Next, the user activates the software application installed on his cellular telephone or tablet computer and establishes communication with data sensing and collection device 100. Next, the user selects what data and how he wishes to see it displayed by the software application. Next, the user flies the flying machine. Finally, the user observes the data collected by data sensing and collection device 100 via the software application.

While the present invention has been described in what are thought to be the most useful and practical embodiments, it will be readily apparent to those having skill in the art that other variations may be readily conceived and created. Accordingly, these and all such other readily conceived and created variations are implicitly included in the spirit and scope of the present disclosure.

What is claimed is:

1. A data sensing and collection device comprising:
a) an aerodynamically configured housing mounted to a stalk adjustable in at least one axis wherein the stalk is adhesively affixed to an exterior aspect of a flying machine and the housing is not attached to the exterior aspect of the flying machine;
b) wherein said housing contains an electronic device comprising:
i. a battery;
ii. a differential pressure sensor and attached pitot tube;
iii. a barometric altimeter (pressure sensor);
iv. a temperature sensor;
v. a gyroscope;
vi. an accelerometer;
vii. a magnetometer;
viii.a microcontroller and storage facility; and
ix. a radio transceiver.

2. A data sensing and collection device of claim 1 wherein said battery is rechargeable and further comprises a battery recharging port.

3. A data sensing and collection device of claim 1 wherein said radio transceiver supports the Bluetooth transmission protocol.

4. A data sensing and collection device of claim 1 wherein said radio transceiver supports the Wi-Fi transmission protocol.

5. A data sensing and collection device of claim 1 further comprising a GPS receiver.

6. A data sensing and collection device of claim 1 further comprising a digital compass.

7. A method of monitoring flight data comprising the steps of:
a) affixing the stalk attached to a data sensing and collection device to the exterior surface of a flying machine;
b) aligning the stalk such that the pitot tube extending from the data sensing and collection device is aligned parallel to the direction of flight;
c) activating a software application running on a cellular telephone or tablet computer; and
d) selecting the type of data to be collected from the data sensing and collection device and displayed on the cellular telephone or tablet computer.

8. A method of monitoring flight data of claim 7 wherein said data comprises airspeed.

9. A method of monitoring flight data of claim 7 wherein said data comprises altitude.

10. A method of monitoring flight data of claim 7 wherein said data comprises temperature.

11. A method of monitoring flight data of claim 7 wherein said data comprises orientation.

12. A method of monitoring flight data of claim 7 wherein said data comprises heading.

13. A method of monitoring flight data of claim 7 wherein said data comprises acceleration.

14. A method of monitoring flight data of claim 7 wherein said data comprises angular rate.
